(19) United States
(12) Patent Application Publication
(10) Pub. No.: US 2004/0008939 A1
(43) Pub. Date: Jan. 15, 2004

(54) Dispersion compensator and wavelength compensation apparatus

(75) Inventor: Asako Baba, Tokyo (JP)

Correspondence Address: BROWDY AND NEIMARK, P.L.L.C., 624 NINTH STREET, NW, SUITE 300, WASHINGTON, DC, 20001-5303, US

(73) Assignee: Matsushita Electric Industrial Co., Ltd., Osaka (JP)

(21) Appl. No.: 10/424,776

(22) Filed: Apr. 29, 2003

(30) Foreign Application Priority Data
Jul. 15, 2002 (JP) P2002-205311

(51) Int. Cl. G02B 6/34; G02B 6/26

(52) U.S. Cl. 385/37; 385/27

(57) ABSTRACT

There is provided a dispersion compensator that solves a problem of loss due to radiation mode and has a wide band and causes smaller insertion loss, and is compact in size and inexpensive. To achieve this, the dispersion compensator is constructed to comprise a fiber Bragg grating subjected to refractive index modulation to reflect lights of various wavelengths, wherein a core part of the fiber Bragg grating includes plural refractive index modulation parts that become continuously shorter in reflection wavelength toward a longitudinal direction from a light incidence side and are in positions different from each other in the longitudinal direction, and a discontinuous part, provided between the refractive index modulation parts, in which reflection wavelength shifts discontinuously to the long wavelength side. Light is inputted and outputted to and from the fiber Bragg grating by use of an optical circulator or the like. With this construction, a dispersion compensator and a wavelength dispersion compensation apparatus are realized which solve the problem of loss due to radiation mode and have a wide band and cause smaller insertion loss, and are compact in size and inexpensive.

### BACKGROUND OF THE INVENTION

1. Field of the Invention

The present invention relates to a method of compensating for wavelength dispersion, and more particularly to a wavelength dispersion compensator and a wavelength dispersion compensation apparatus used for optical fiber communications.

2. Description of Prior Art

Recently, the introduction of optical fiber communications to an optical subscriber system has been pushed ahead. In a case where light of 1.5 μm (micron) band having low transmission loss is used, since wavelength dispersion of 17 ps/km·nm occurs, the need to compensate for dispersion increases for increasing transmission speeds. In view of introduction to a subscriber system, since light transmission distances differ depending on subscribers, compensation must be made to suit individual transmission distances.

Conventional dispersion compensators compensate for wavelength dispersion by use of dispersion compensation fibers having dispersion characteristics reverse to the dispersion characteristics of normal optical fibers. Such a method requires more than several kilometers of dispersion compensation fibers for compensating for dispersion and is disadvantageous in that its size cannot be miniaturized.

On the other hand, a fiber Bragg grating in which gratings are formed in a core part of an optical fiber has the characteristic of reflecting light of some wavelengths, and functions as an element having the characteristic of having different reflection positions for different light wavelengths by forming gratings whose periods are changed toward a longitudinal direction of the optical fiber. A compact wavelength dispersion compensation apparatus taking advantage of that characteristic to realize dispersion compensation is described in Japanese Patent Disclosure No. 7-128524). The construction of the wavelength dispersion compensation apparatus is shown in FIG. 1.

In FIG. 1, the incidence end and exit end of a directional coupler 71 are respectively connected to terminals 72, 73, and 74. Another end of the terminal 72 is connected to an optical fiber 75, and another end of the terminal 73 is connected to a fiber Bragg grating 76 in which gratings whose grating intervals change continuously are formed. The fiber Bragg grating 76 is supported by a supporting member 77. A wavelength dispersion compensator 78 is composed of the fiber Bragg grating 76 and the supporting member 77.

Hereinafter, the operation of the wavelength dispersion compensation apparatus will be described with reference to the figure. From the optical fiber 75, signal light undergoing wavelength dispersion is inputted to the directional coupler 71 through the terminal 72 and inputted to the wavelength dispersion compensator 78 through the terminal 73. The wavelength dispersion compensator 78 has a polarity opposite to the wavelength dispersion of the signal light inputted from a light input/output end 76a and uses a reverse wavelength dispersion value so that the overall value of wavelength dispersion is identical. Therefore, wavelength dispersion generated in the wavelength dispersion compensator 78 compensates for the wavelength dispersion of the light signal inputted from the terminal 72, and signal light compensated for wavelength dispersion is outputted from the light input/output end 76a of the wavelength dispersion compensator 78, inputted to the directional coupler 71 from the terminal 73, and then outputted from the terminal 74. In this way, a light signal compensated for wavelength dispersion is obtained.

However, dispersion in wavelength band 1.5 Am of a single mode fiber used in a light transmission line is fast in the short wavelength side and slow in the long wavelength side. Therefore, in the case of dispersion compensation using a fiber Bragg grating, the fiber Bragg grating must be connected so that a reflection point of the long wavelength side is closer to an input/output end of light than a reflection point of the short wavelength side. The fiber Bragg grating formed in the signal mode fiber causes radiation mode loss in continuous wavelength bands below a certain wavelength that is shorter than a Bragg wavelength (λb) corresponding to a grating period. If the refractive index of the fiber Bragg grating is n_{c0}, the refractive index of cladding is n_{c1}, the period of grating is Λ, and the number of radiation mode is p, wavelength λ_{L} in which radiation mode loss begins is given by the following formula:

λ_{L}Λ(p)·(_{c0}−n_{c1}((p))

Here, wavelengths below λ_{L} suffer radiation mode loss. Therefore, if light is incident on the fiber Bragg grating whose grating intervals change continuously, wavelength bands of the short wavelength side suffer radiation mode loss. As a result, a band in which a reflectance close to 100% is obtained is about 1 nm, and is no more than several nm even in special fibers that have a high confinement capability and a relative large (λ_{b}−λ_{L}) value. Although research into fibers causing no radiation mode loss is underway, they are expensive and cause coupling loss because of bad matching with single mode fibers. Chirp amounts of DFB lasers used in optical communications are about 0.02 to 0.05 nm, which are sufficient even in the band 1 nm possible with the fiber Bragg grating. However, since the wavelengths of individual lasers have a variation of about 5 nm, the band must be kept with a high reflectance.

Therefore, the present invention solves conventional problems as described above and an object thereof is to provide a wavelength dispersion compensator and a wavelength dispersion compensation apparatus that have a wide band and cause smaller loss, and are compact in size and inexpensive.

### SUMMARY OF THE INVENTION

To achieve the above-described object, a dispersion compensator of the present invention has a fiber Bragg grating, wherein a core part of the fiber Bragg grating includes plural refractive index modulation parts that become continuously shorter in reflection wavelength toward a longitudinal direction from a light incidence side and are in positions different from each other in the longitudinal direction, and discontinuous parts, provided between the plural refractive index modulation parts, in which reflection wavelength shifts discontinuously to the long wavelength side. This construction helps solve radiation mode loss due to the radiation mode, which has been a problem of dispersion compensation using conventional fiber Bragg gratings, and contributes to the realization of a dispersion compensator that has a wide band and causes lower insertion loss, and is compact in size and inexpensive.

The dispersion compensator of the present invention is characterized in that pitches of the gratings in the refractive index modulation parts become smaller toward the longitudinal direction, contributing to compensating for greater amounts of dispersion as well as providing the above-described effects.

The dispersion compensator of the present invention is characterized in that pitches of the gratings in the refractive index modulation parts become smaller toward the longitudinal direction, and effective refractive indexes in the refractive index modulation parts change continuously, contributing to the realization of a dispersion compensator that enables compensation for dispersion of an amount different from a dispersion amount determined by a change rate of pitches by continuously changing effective refractive indexes in the refractive index modulation part.

A dispersion compensator of the present invention is characterized in that it has plural refractive index modulation parts in which pitches of the gratings in the refractive index modulation parts are constant toward the longitudinal direction, and effective refractive indexes in the refractive index modulation parts change continuously. Since the dispersion compensator functions as a grating of a small chirp amount based on the principle that reflection wavelength changes according to changes in effective refractive indexes, it can compensate for a large amount of dispersion.

A dispersion compensator of the present invention is characterized in that the discontinuous parts contain portions free from refractive index modulation. Even if the discontinuous parts contain portions free from refractive index modulation, the present invention can be implemented.

A dispersion compensator of the present invention is characterized in that a module for applying tension in a longitudinal direction to the fiber Bragg grating is provided. Since applying tension in a longitudinal direction to the fiber Bragg grating causes reflection wavelength of the discontinuous part to be shifted to the long wavelength side by a predetermined amount, the dispersion compensator can compensate for dispersion even if wavelength in the discontinuous part is used.

A dispersion compensator of the present invention is characterized in that the fiber Bragg grating is provided with a module for adjusting fiber temperatures. Since heating the fiber Bragg grating to expand it causes reflection wavelength of the discontinuous part to be shifted to the long wavelength side by a predetermined amount, the dispersion compensator can compensate for dispersion even if wavelength in the discontinuous part is used.

A wavelength dispersion compensation apparatus of the present invention is characterized in that it comprises a three-terminal optical circulator with one input/output terminal and one of the above-described dispersion compensators, wherein an input/output end of the optical circulator is connected to an input/output end of the fiber Bragg grating of the dispersion compensator. By this construction, a wavelength dispersion compensation apparatus can be realized which has a wide band and is free from radiation mode loss due to the radiation mode.

A wavelength dispersion compensation apparatus of the present invention is characterized in that it comprises a four-terminal optical circulator with two input/output terminals and two of the above-described dispersion compensators, wherein each input/output end of the optical circulator is connected to an input/output end of each of the fiber Bragg gratings of the two dispersion compensators. By this construction, a wavelength dispersion compensation apparatus can be realized which has a wide band and is free from radiation mode loss due to the radiation mode.

A wavelength dispersion compensation apparatus of the present invention includes a directional coupler and one of the above-described dispersion compensators, wherein an input/output terminal of the directional coupler is connected to an-input/output end of a fiber Bragg grating of the dispersion compensator. By this construction, an inexpensive wavelength dispersion compensation apparatus can be realized which has a wide band and is free from radiation mode loss due to the radiation mode.

A wavelength dispersion compensation apparatus of the present invention is characterized in that the core part of the fiber Bragg grating is provided with at least one refractive index modulation part having a reflective wavelength filter function. By this construction, a reflection discontinuous band of the fiber Bragg grating can be avoided, and an inexpensive wavelength dispersion compensation apparatus can be realized which has a wide band and is free from radiation mode loss due to the radiation mode.

A wavelength dispersion compensation apparatus of the present invention includes a wavelength filter connected to the input/output end of the fiber Bragg grating. By this construction, a reflection discontinuous band of the fiber Bragg grating can be avoided by branching light of specific wavelengths in two directions by a wavelength filter, and an inexpensive wavelength dispersion compensation apparatus can be realized which has a wide band and is free from radiation mode loss due to the radiation mode.

As has been described above, in the dispersion compensator and the wavelength dispersion compensation apparatus of the present invention, the core part of the fiber Bragg grating includes plural refractive index modulation parts that become continuously shorter in reflection wavelength toward a longitudinal direction from a light incidence side and are in positions different from each other in the longitudinal direction, and a discontinuous part, provided between the plural refractive index modulation parts, in which reflection wavelength shifts discontinuously to the long wavelength. This construction helps solve radiation mode loss due to the radiation mode, which has been a problem of dispersion compensation using conventional fiber Bragg gratings, and contributes to the realization of a dispersion compensator and a wavelength dispersion compensation apparatus that have a wide band and causes lower insertion loss, and are compact in size and inexpensive. Their practical effects are great.

An object of the present invention is to provide a wavelength dispersion compensator and a wavelength dispersion compensation apparatus that have a wide band and cause less radiation mode loss, and are compact in size and inexpensive.

The above-described object and advantages of the present invention will become more apparent from the following embodiments described with reference to the drawings.

### BRIEF DESCRIPTION OF THE DRAWINGS

FIG. 1 is a diagram schematically showing the construction of a conventional wavelength dispersion compensation apparatus;

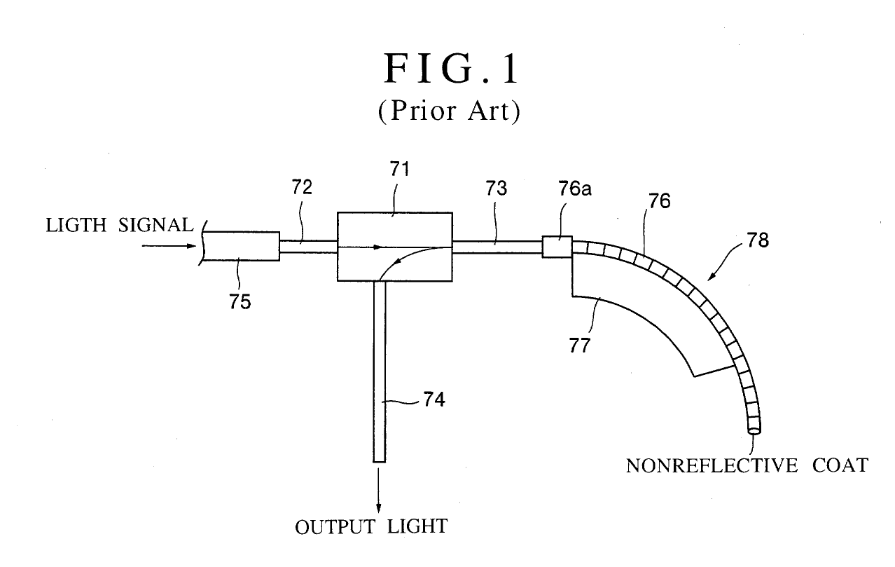

FIG. 2 is a diagram schematically showing the overall construction of the wavelength dispersion compensation apparatus in a first embodiment of the present invention;

FIG. 3 is a principle diagram showing a relationship between reflection positions and reflection wavelengths in a fiber Bragg grating in embodiments of the present invention;

FIG. 4 is a characteristic diagram showing a relationship between delay times and wavelengths of a dispersion compensator prototyped in the first embodiment of the present invention;

FIG. 5 is a characteristic diagram showing reflection intensities of a fiber Bragg grating mounted in a dispersion compensator prototyped in the first embodiment of the present invention;

FIG. 6 is a diagram schematically showing the overall construction of a wavelength dispersion compensation apparatus in a second embodiment of the present invention; and

FIG. 7 is a diagram schematically showing the overall construction of a wavelength dispersion compensation apparatus in a third embodiment of the present invention.

### DESCRIPTION OF THE PREFERRED EMBODIMENTS

Hereinafter, embodiments of the present invention will be described with reference to the drawings.

(First Embodiment)

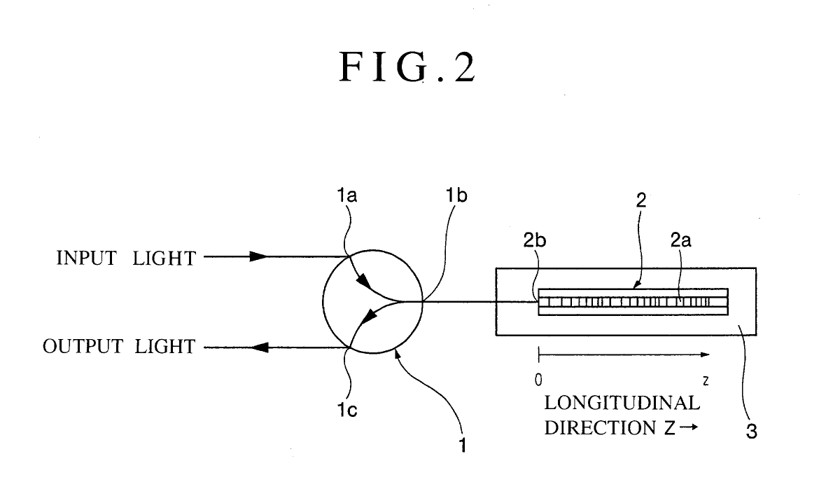

FIG. 2 schematically shows the overall construction of a wavelength dispersion compensation apparatus in the first embodiment of the present invention. In FIG. 2, an optical circulator 1 has three terminals: input terminal la, input/output terminal 1b, and output terminal 1c. A fiber Bragg grating 2 constituting a dispersion compensator has plural refractive index modulation parts in a core part 2a surrounded by a cladding, and an input/output end 2b at the side of the optical circulator 1. A tension applying module 3 applies tension to the fiber Bragg grating 2 in a longitudinal direction Z.

In the above construction, dispersion compensation operation will be described below. A normal single mode fiber has a dispersion amount of about 17 ps for a wavelength difference of 1 nm and causes a delay time of 17 Xps/nm for signal light transmission of X km with a higher transmission speed at the short wavelength side. Light thus undergoing wavelength dispersion is inputted to the input terminal 1a of the optical circulator 1, exits from the input/output terminal 1b, and enters the input/output end 2b of the fiber Bragg grating 2. The light incident on the fiber Bragg grating 2 is reflected in reflection positions z different among wavelengths by the action of the refractive index modulation parts of the core part 2a.

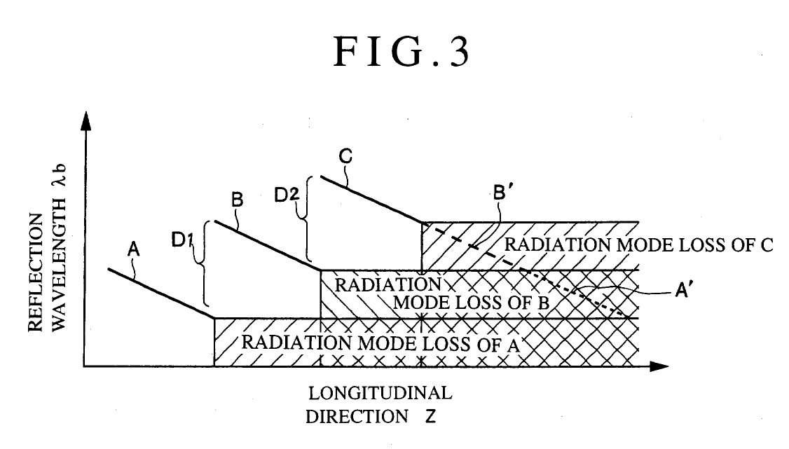

FIG. 3 shows a relationship between reflection positions and reflection wavelengths in the fiber Bragg grating 2. As shown in FIG. 3, the core part 2a of the fiber Bragg grating 2 is provided with plural refractive index modulation parts A, B, and C via discontinuous parts D1 and D2. The refractive index modulation parts A, B, and C are provided so that they become continuously shorter in reflection wavelength toward a longitudinal direction Z from the light input/output end 2b and are in positions different from each other in the longitudinal direction Z. The discontinuous parts D1 and D2 are discontinuous in reflection wavelengths λb between the refractive index modulation parts A and B and between the refractive index modulation parts B and C. Yet, the discontinuous part D1 shifts in reflection wavelength kb to the long wavelength side from the refractive index modulation part A to the refractive index modulation part B, and the discontinuous part D2 shifts in reflection wavelength λb to the long wavelength side from the refractive index modulation part B to the refractive index modulation part C.

Conventionally, the grating has been straight continuous as shown by A′, B′, and C in FIG. 3. However, such a construction has caused the radiation mode loss effected by the grating C to decrease the reflectances of the gratings A′ and B′.

In contrast, in this embodiment, gratings are discontinuously placed like A, B, and C, with B′ provided closer to the input/output end than C like B, whereby the radiation loss of the C can be avoided. Likewise, by providing A′ closer to the input/output end than B, the radiation mode loss of the C and B can be avoided. In this way, except for the wavelengths of the discontinuous parts D1 and D2 existing at the junction points of A, B, and C, lights reflected in the refractive index modulation parts A, B, and C of the fiber Bragg grating are compensated for dispersion because their respective delay times are canceled out.

Here, a description will be made of a relationship between delay times and wavelengths in this embodiment. A relationship between reflection wavelength λ and reflection position z is represented by the following formula:

λ=R(z),

where R is a function.

A relationship between reflection position z and delay time resulting from differences of reflection positions τ is represented by the following formula:

τ=2·(n/c)·z,

where n is refractive index and c is light speed.

Therefore, this relation can be represented as follows if it is replaced by a relationship between delay time and wavelength required for dispersion compensation:

τ=2·(n/c)·R⁻¹(λ),

where R⁻¹ is an inverse function of R.

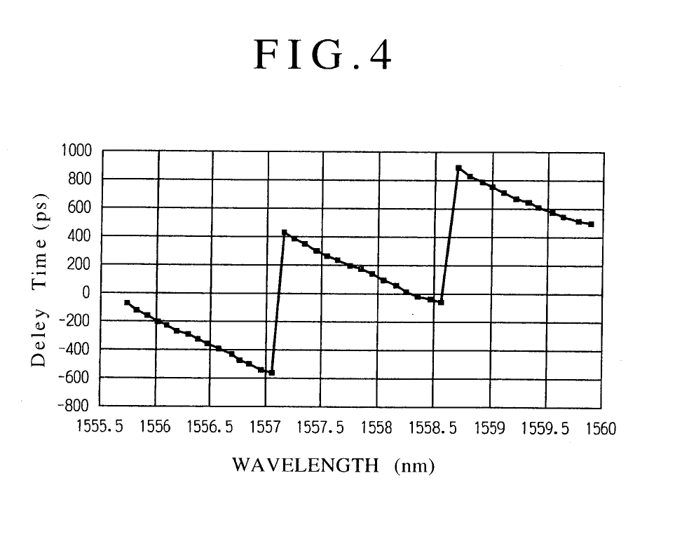

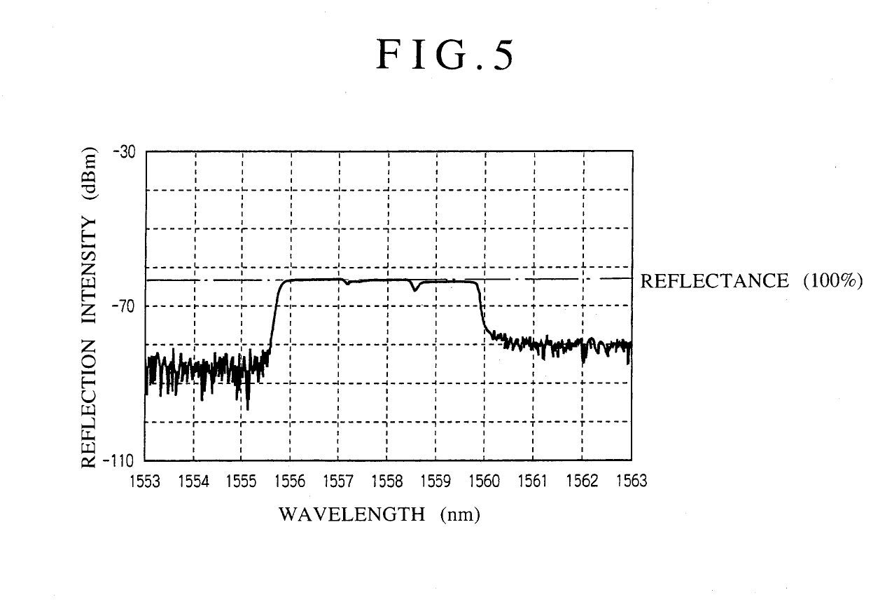

FIG. 4 shows a relationship between delay times and wavelengths of the dispersion compensator prototyped in this embodiment. This graph shows a dispersion compensator designed for a transmission distance of about 20.6 km with delay time −350.8 ps/nm. Wavelengths eligible for dispersion compensation are in the range from 1555.7 to 1559.8 nm except for discontinuous parts 1557.2 nm and 1558.7 nm. FIG. 5 shows reflection intensities of the fiber Bragg grating 2 of the dispersion compensator prototyped in this embodiment. It is understood that high reflectances are achieved in a wavelength band 1555.7 to 1559.8 nm eligible for dispersion compensation, and the short wavelength side does not undergo the influence of radiation mode loss at all.

Next, a description will be made of the case where the wavelengths 1557.2 nm and 1558.7 nm of the discontinuous parts are used. The fiber Bragg grating 2 of the dispersion compensation in this embodiment includes the tension applying module 3. The tension applying module 3 applies tension to the fiber Bragg grating 2 by pulling it with its both ends held in the longitudinal direction Z. Upon receipt of tension, the fiber Bragg grating 2 becomes larger in diffraction period and shifts in wavelength at a rate of about 0.0133 nm/g. Accordingly, if tension of about 300 g is applied, the wavelength band can be shifted to a longer wavelength by about 0.4 nm, so that dispersion can be compensated even in the case where the wavelengths 1557.2 nm and 1558.7 nm of the discontinuous parts are used.

In this way, according to the first embodiment, the core part of the fiber Bragg grating is provided with plural refractive index modulation parts that become continuously shorter in reflection wavelength toward a longitudinal direction Z from a light incidence side via the discontinuous parts D1 and D2 in which reflection wavelength shifts discontinuously to the long wavelength side. This construction helps solve radiation mode loss due to the radiation mode, which has been a problem of dispersion compensation using fiber Bragg gratings, and contributes to the realization of a dispersion compensator that has a wide band and causes lower insertion loss, and is compact in size and inexpensive.

Although, in the first embodiment, reflection wavelengths and reflection positions of the fiber Bragg grating 2 are in a relationship that includes two discontinuous parts (D1 and D2) among the refractive index modulation parts A, B, and C as shown in FIG. 3, since discontinuous parts are provided between refractive index modulation parts, the number of discontinuous parts increases in proportion to the number of refractive index modulation parts. Although one fiber Bragg grating 2 is used in this embodiment, plural fiber Bragg gratings 2 coupled in the longitudinal direction Z may be treated as one fiber Bragg grating.

In the first embodiment, to obtain a dispersion curve with a small amount of ripple in the refractive index modulation parts compensating for dispersion, apodization is effectively applied so that reflectances increase gradually in the long wavelength side and decrease gradually in the short wavelength side. In this case, applying the apodization would reduce reflectances in the vicinity of wavelengths that become discontinuous in the plural refractive index modulation parts compensating for dispersion. Accordingly, as in the case of avoiding discontinuous wavelengths by the tension applying module 3, tension may be applied to shift wavelengths with smaller reflectances by the tension applying module 3.

In the first embodiment, as the fiber Bragg grating 2, so-called chirp gratings are placed so that the pitches of the gratings in the refractive index modulation parts become gradually smaller toward the longitudinal direction Z from the input/output end 2b. Pitches between adjacent chirp gratings may become successively discontinuously larger in the longitudinal direction Z. In this case, a larger amount of dispersion can be compensated. Effective refractive indexes in the refractive index modulation parts may be continuously changed. In this case, dispersion compensation elements of dispersion amounts different from dispersion amounts determined by a change rate of period can be provided. There may be provided plural refractive index modulation parts in which pitches of the gratings are constant, and effective refractive indexes change continuously within a range of a constant period. In this case, since the principle that reflection wavelengths change according to a change in effective refractive indexes is used, the gratings have a small amount of chirp, so that a large amount of dispersion can be compensated. The fiber Bragg gratings 2 may contain portions free from refractive index modulation in discontinuous parts between adjacent refractive index modulation parts. The present invention may be implemented without problem even if the discontinuous parts contain portions subject to refractive index modulation.

Although, in the first embodiment, the tension applying module 3 is used to avoid the problem that wavelength dispersion cannot be made in the discontinuous parts, wavelengths in the discontinuous parts may be shifted to the long wavelength side by mounting a temperature control module to heat and expand the fiber Bragg grating 2. As the temperature control module, a heater may be attached to a fiber on which the gratings are formed, or means for mounting Peltier elements may be used. A fiber Bragg grating having different wavelengths in discontinuous parts is provided in advance and may be attached to an optical circulator according to the wavelength of inputted light. In a case where the wavelength of light inputted is different from the wavelength of the discontinuous parts, the tension applying module 3 for shifting wavelength in the discontinuous parts may not be used.

A directional coupler may be used in place of the three-terminal optical circulator 1 used to input and output light in the first embodiment. In place of the three-terminal optical circulator 1, a four-terminal optical circulator may be used to connect the input/output terminals of the optical circulator respectively to input/output ends of two fiber Bragg gratings 2. A dispersion amount in this case is the total of dispersion compensation amounts of the fiber Bragg gratings in the two input/output terminals of the optical circulator.

(Second Embodiment)

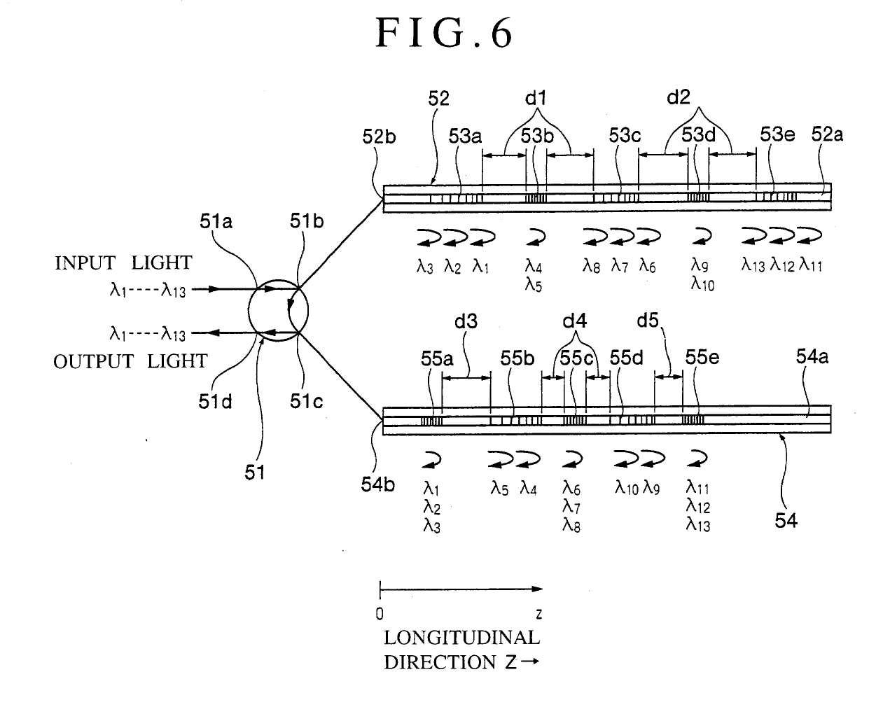

FIG. 6 schematically shows the overall construction of a wavelength dispersion compensation apparatus in a second embodiment of the present invention. In FIG. 6, an optical circulator 51 is a four-terminal optical circulator having an input terminal 51a, two input/output terminals 51b, 51c and an output terminal 51d. In a first fiber Bragg grating 52, a core part 52a has five refractive index modulation parts 53a, 53b, 53c, 53d, and 53e, and an input/output end 52b is connected to a first input/output terminal 51b of the optical circulator 51. In a second fiber Bragg grating 54, a core part 54a has five refractive index modulation parts 55a, 55b, 55c, 55d, and 55e, and an input/output end 54b is connected to a second input/output terminal 51c of the optical circulator 51.

The refractive index modulation parts 53a, 53c, and 53e of the first fiber Bragg grating 52, like FIG. 3 in the first embodiment, become continuously shorter in reflection wavelength toward a longitudinal direction Z from the light input/output end 52b and are in positions different from each other in the longitudinal direction Z, affording time delay for compensating wavelength dispersion. Modulation periods or grating pitches in the refractive index modulation parts 53a, 53c, and 53e become gradually shorter toward the longitudinal direction Z. Among the refractive index modulation parts 53a, 53c, and 53e, the refractive index modulation parts 53b and 53d with a constant pitch not causing wavelength dispersion are formed via portions d1 and d2 free from modulation.

The refractive index modulation parts 55b and 55d of the second fiber Bragg grating 54, like FIG. 3 in the first embodiment, become continuously shorter in reflection wavelength toward the longitudinal direction Z from the light input/output end 54b and are in positions different from each other in the longitudinal direction Z, affording time delay for compensating wavelength dispersion. Modulation periods in the refractive index modulation parts 55b and 55d become gradually shorter toward the longitudinal direction Z. Around the refractive index modulation parts 55b and 55d, the refractive index modulation parts 55a, 55c, and 55e having a wavelength filter function with a constant pitch not causing wavelength dispersion are formed via portions d3, d4, and d5 free from modulation.

In the above construction, dispersion compensation operation will be described below. In the second embodiment, plural lights having different wavelengths (so-called wavelength multiplex lights) are subjected to dispersion compensation and their individual wavelengths are fixed. The respective wavelengths of the lights used here are λ1 and λ2 to λ13 in ascending order of wavelength. Lights of wavelength λ undergoing wavelength dispersion are inputted to the input/output end 51b of the optical circulator 51 and enter the input/output end 52b of the first fiber Bragg grating 52. The lights incident on the first fiber Bragg grating 52 reflect in reflection positions z different for different wavelengths due to refractive index modulation action of the core part 52a. In the refractive index modulation part 53a, the dispersions of lights λ3, λ2, and λ1 are compensated in the longitudinal direction Z; in the refractive index modulation part 53c, the dispersions of lights λ8, λ7, and λ6 are compensated in the longitudinal direction Z; and in the refractive index modulation part 53e, the dispersions of lights λ3, λ12, and λ11 are compensated in the longitudinal direction Z. In the refractive index modulation part 53b between the refractive index modulation parts 53a and 53c, lights of wavelengths λ4 and λ5 are reflected without being compensated for dispersion. Likewise, in the refractive index modulation part 53d between the refractive index modulation parts 53c and 53e, lights of wavelengths λ9 and λ10 are reflected without being compensated for dispersion. Of course, the refractive index modulation parts are placed based on the principle shown in FIG. 3 so that the lights of the wavelengths do not suffer radiation mode loss of the gratings.

The lights of λ1 to λ13 reflected in the first fiber Bragg grating 52 are inputted again to the first input/output terminal 51b of the optical circulator 51 from the input/output terminal 52b, and then are inputted to the input/output end 54b of the second fiber Bragg grating 54 from the second input/output terminal 51c. Here, the lights (λ4 and λ5, and λ9 and λ10) not compensated for dispersion are compensated for dispersion in the refractive index modulation parts 55b and 55d, respectively, and lights of λ1, λ2, and λ3, lights of λ6, λ7, and λ8, and lights of λ11, λ12, and λ13 are reflected in the refractive index modulation parts 55a, 55c, and 55e, respectively, without being subjected to wavelength dispersion. Also in this case, the refractive index modulation parts are placed so that the lights of the wavelengths do not suffer radiation mode loss of the gratings according to the principle shown in FIG. 3. The lights λ1 to λ13 thus reflected in the fiber Bragg grating 54 are compensated for dispersion whatever their wavelength, inputted to the second input/output terminal 51c of the optical circulator 51, and outputted from the output terminal 51d.

In this way, according to the second embodiment, lights subjected to wavelength dispersion from the optical circulator 51 are subjected to reverse dispersions by the two fiber Bragg gratings 52 and 54, and moreover, by use of the two fiber Bragg gratings 52 and 54 in which the refractive index modulation parts are placed to avoid the influence of radiation loss, a compact and inexpensive wavelength dispersion compensation apparatus can be realized which solves the problem of radiation mode loss due to the radiation mode that would be caused if conventional fiber Bragg gratings were used, and has a wide band and causes lower insertion loss.

In the second embodiment, to obtain a dispersion curve with a small amount of ripple in the refractive index modulation parts compensating for dispersion, apodization is effectively applied so that reflectances increase gradually in the long wavelength side and decrease gradually in the short wavelength side. Applying the apodization would reduce reflectances in the vicinity of wavelengths that become discontinuous in the plural refractive index modulation parts 53a, 53c, 53e, 55b, and 55d compensating for dispersion. Accordingly, lights of wavelengths in the vicinity of the discontinuous parts are reflected without being compensated and may be compensated in another fiber Bragg grating. Therefore, the construction of the two fiber Bragg gratings as in the second embodiment is effective.

Although, in the second embodiment, the first fiber Bragg grating 52 and the second fiber Bragg grating 54 have five refractive index modulation parts respectively, any number of them may be placed if the number is two or more. A four-terminal directional coupler may be used in place of the four-terminal optical circulator 51 used to input and output light in the second embodiment.

In the second embodiment, as the fiber Bragg gratings 52 and 54, plural so-called chirp gratings are placed so that the periods of the refractive index modulation parts 53a, 53c, 53e, 55b, and 55d become gradually smaller toward the longitudinal direction Z from the input/output ends 52b and 54b. Effective refractive indexes in the individual refractive index modulation parts may be continuously changed. In this case, dispersion compensator of dispersion amounts different from dispersion amounts determined by a change rate of period can be realized. The modulation periods of the refractive index modulation parts 53a, 53c, 53e, 55b, and 55d may be constant and their effective refractive indexes may change continuously. In this case, since the principle that reflection wavelengths change according to a change in effective refractive indexes is used, the gratings have a small amount of chirp, so that a large amount of dispersion can be compensated. The plural refractive index modulation parts may have modulation periods different from each other and increase in effective refractive index toward the longitudinal direction Z. The fiber Bragg gratings 52 and 54 may contain portions free from refractive index modulation in discontinuous parts between adjacent refractive index modulation parts.

(Third Embodiment)

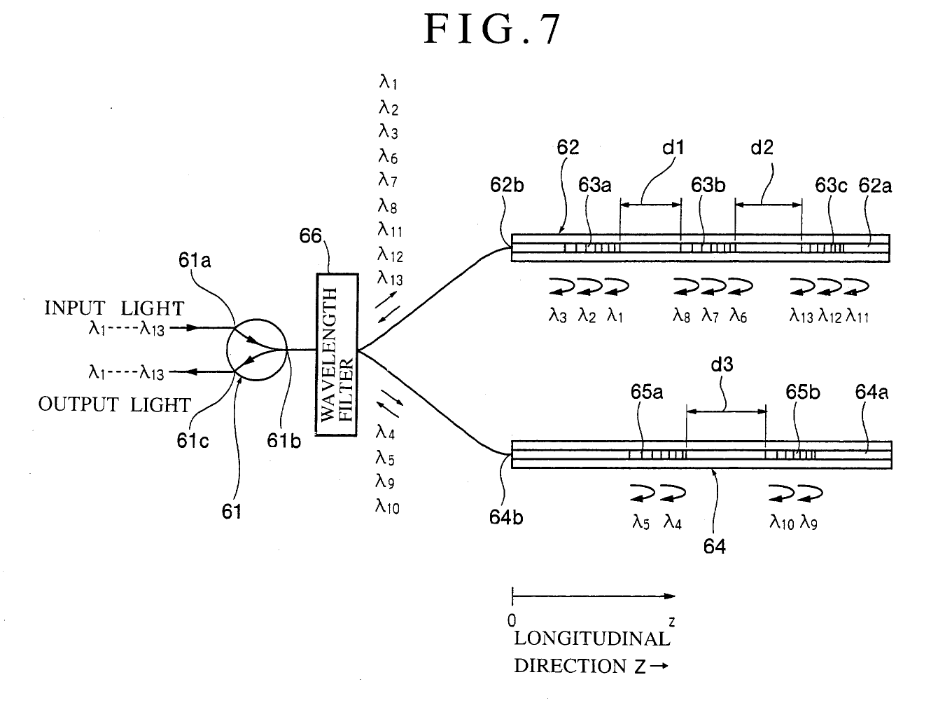

FIG. 7 is a diagram schematically showing the overall construction of a wavelength dispersion compensation apparatus in a third embodiment of the present invention. In FIG. 7, an optical circulator 61 is a three-terminal optical circulator having an input terminal 61a, an input/output terminal 61b, and an output terminal 61c. In a first fiber Bragg grating 62, a core part 62a has three refractive index modulation parts 63a, 63b, and 63c, and an input/output end 62b is connected to an input/output terminal 61b of the optical circulator 61 via a wavelength filter 66. In a second fiber Bragg grating 64, a core part 64a has two refractive index modulation parts 65a and 65b, and an input/output end 64b is connected to an input/output terminal 61b of the optical circulator 61 via the wavelength filter 66.

The refractive index modulation parts 63a, 63b, and 63c of the first fiber Bragg grating 62, like FIG. 3 in the first embodiment, become continuously shorter in reflection wavelength toward a longitudinal direction Z from the light input/output end 62b and are in positions different from each other in the longitudinal direction Z, affording time delay for compensating wavelength dispersion. Modulation periods or grating pitches in the refractive index modulation parts 63a, 63b, and 63c become gradually shorter toward the longitudinal direction Z. Among the refractive index modulation parts 63a, 63b, and 63c, portions d1 and d2 free from modulation are formed.

The refractive index modulation parts 65a and 65b of the second fiber Bragg grating 64, like FIG. 3 in the first embodiment, become continuously shorter in reflection wavelength toward the longitudinal direction Z from the light input/output end 64b and are in positions different from each other in the longitudinal direction Z, affording time delay for compensating wavelength dispersion. Modulation periods or grating pitches in the refractive index modulation parts 65a and 65b become gradually shorter toward the longitudinal direction Z. Between the refractive index modulation parts 65a and 65b, a portion d3 free from modulation is formed.

In the above construction, dispersion compensation operation will be described below. In the third embodiment, like the second embodiment, plural lights having different wavelengths (so-called wavelength multiplex lights) are subjected to dispersion compensation and their individual wavelengths are fixed. The respective wavelengths of the lights used here are λ1 and λ2 to λ13 in ascending order of wavelength.

In the third embodiment, as compared to the second embodiment, refractive index modulation in the fiber Bragg gratings 62 and 64 is made in only the refractive index modulation parts 63a, 63b, 63c, 65a, and 65b affording time delay for compensating for dispersion, and the wavelength filter 66 is placed between the optical circulator 61 and the fiber Bragg gratings 62 and 64 in place of reflective refractive index modulation parts with a constant pitch not affording time delay. To avoid lights of discontinuous wavelengths of reflection wavelengths of the fiber Bragg gratings 62 and 64, incident lights are branched to two directions by the wavelength filter 66 so that λ1, λ2, λ3, λ6, λ7, λ8, λ11, λ12, and λ13 are incident on the first fiber Bragg grating 62 and λ4, λ5, λ9, and λ10 are incident on the second fiber Bragg grating 64. The lights incident on the fiber Bragg gratings 62 and 64 reflect due to refractive index modulation action of the fiber Bragg gratings, respectively, and are compensated for dispersion, as in the second embodiment. Of course, the refractive index modulation parts are placed based on the principle shown in FIG. 3 so that the lights of the wavelengths do not suffer radiation mode loss of the gratings. The lights of the wavelengths compensated for dispersion in the fiber Bragg gratings 62 and 64 enter the wavelength filter 66 again and are outputted from the output terminal 61c through the input/output terminal 61b of the optical circulator 61.

According to the third embodiment, by use of the two fiber Bragg gratings 62 and 64 having the refractive index modulation parts affording time delay for compensating for dispersion, and the wavelength filter 66 for branching light to two directions to avoid lights of discontinuous wavelengths of reflection wavelengths of the fiber Bragg gratings 62 and 64, reflection discontinuous bands of the fiber Bragg gratings 62 and 64 can be avoided and lights of different wavelengths can be compensated for dispersion. As a result, an inexpensive dispersion compensator can be realized which is free from the influence of radiation loss of the fiber Bragg gratings, causes lower insertion loss, and is compact in size.

In the third embodiment, apodization may be applied to the refractive index modulation parts. In the fiber Bragg gratings 62 and 64, any number of refractive index modulation parts may be placed if the number is two or more. A directional coupler may be used in place of the three-terminal optical circulator 61 used to input and output light.

In the third embodiment, as the fiber Bragg gratings 62 and 64, so-called chirp gratings are placed so that the periods of the refractive index modulation parts 63a, 63b, 63c, 65a, and 65b become gradually smaller toward the longitudinal direction Z from the input/output ends 62b and 64b. However, effective refractive indexes in the refractive index modulation parts may be continuously changed. In this case, dispersion compensation elements of dispersion amounts different from dispersion amounts determined by a change rate of period can be provided. The fiber Bragg gratings 62 and 64 may contain portions free from refractive index modulation in discontinuous parts between adjacent refractive index modulation parts.

As has been described above, a dispersion compensator and a wavelength dispersion compensation apparatus of the present invention have a fiber Bragg grating, wherein the core part of the fiber Bragg grating includes plural refractive index modulation parts that become continuously shorter in reflection wavelength toward a longitudinal direction from a light incidence side and are in positions different from each other in the longitudinal direction, and discontinuous parts, provided between the refractive index modulation parts, in which reflection wavelength shifts discontinuously to the long wavelength side. Therefore, a dispersion compensator and a wavelength dispersion compensation apparatus can be realized which solve radiation mode loss due to the radiation mode, which has been a problem of dispersion compensation using conventional fiber Bragg gratings, have a wide band and cause lower insertion loss, and are compact in size and inexpensive. Their practical effects are great.

Although the present invention has been described based on preferred embodiments shown in the drawings, it is apparent that those skilled in the art may easily make various modifications and changes without departing from the spirit and scope of the present invention. The present invention also contains such modifications.

What is claimed is:

1. A dispersion compensator including a fiber grating, wherein a core part of said fiber Bragg grating includes:
plural refractive index modulation parts that become continuously shorter in reflection wavelength toward a longitudinal direction from a light incidence side and are in positions different from each other in the longitudinal direction; and
discontinuous parts, provided between said plural refractive index modulation parts, in which reflection wavelength shifts discontinuously to the long wavelength side.

2. The dispersion compensator according to claim 1, wherein pitches of gratings in said refractive index modulation parts become smaller toward said longitudinal direction.

3. The dispersion compensator according to claim 1, wherein pitches of the gratings in said refractive index modulation parts become smaller toward said longitudinal direction, and effective refractive indexes in said refractive index modulation parts change continuously.

4. The dispersion compensator according to claim 1, including plural refractive index modulation parts in which pitches of the gratings in said refractive index modulation parts are constant toward said longitudinal direction, and effective refractive indexes in said refractive index modulation parts change continuously.

5. The dispersion compensator according to claim 1, wherein said discontinuous parts contain portions free from refractive index modulation.

6. The dispersion compensator according to claim 1, including a module for applying tension in a longitudinal direction to said fiber Bragg grating.

7. The dispersion compensator according to claim 1, wherein said fiber Bragg grating is provided with a module for adjusting fiber temperatures.

8. A wavelength dispersion compensation apparatus comprising a three-terminal optical circulator with one input/output terminal and a dispersion compensator including a fiber Bragg grating having a core part, the core part of the fiber Bragg grating including plural refractive index modulation parts that become continuously shorter in reflection wavelength toward a longitudinal direction from a light input/output end and are in positions different from each other in the longitudinal direction, and discontinuous parts, provided between said plural refractive index modulation parts, in which reflection wavelength shifts discontinuously to the long wavelength side,
wherein an input/output end of said optical circulator is connected to an input/output end of the fiber Bragg grating of said dispersion compensator.

9. A wavelength dispersion compensation apparatus comprising a four-terminal optical circulator with two input/output terminals and two dispersion compensators including a fiber Bragg grating having a core part, the core part of the fiber Bragg grating including plural refractive index modulation parts that become continuously shorter in reflection wavelength toward a longitudinal direction from a light input/output end and are in positions different from each other in the longitudinal direction, and discontinuous parts, provided between said plural refractive index modulation parts, in which reflection wavelength shifts discontinuously to the long wavelength side,
wherein each input/output end of said optical circulator is connected to an input/output end of each of the respective fiber Bragg gratings of said two dispersion compensators.

10. A wavelength dispersion compensation apparatus comprising a directional coupler and at least one dispersion compensator including a fiber Bragg grating having a core part, the core part of the fiber Bragg grating including plural refractive index modulation parts that become continuously shorter in reflection wavelength toward a longitudinal direction from a light input/output end and are in positions different from each other in the longitudinal direction, and discontinuous parts, provided between said plural refractive index modulation parts, in which reflection wavelength shifts discontinuously to the long wavelength side,
wherein an input/output terminal of said directional coupler is connected to an input/output end of a fiber Bragg grating of said dispersion compensator.

11. The wavelength dispersion compensation apparatus according to claim 8, wherein the core part of said fiber Bragg grating is provided with at least one refractive index modulation part having a reflective wavelength filter function.

12. The wavelength dispersion compensation apparatus according to claim 8, including a wavelength filter connected to the input/output end of said fiber Bragg grating.
